(19) United States
(12) Patent Application Publication
(10) Pub. No.: US 2014/0210844 A1
(43) Pub. Date: Jul. 31, 2014

(54) METHOD AND SYSTEM FOR REAL-TIME LENS FLARE RENDERING

(71) Applicants: Matthias Hullin, Saarbrucken (DE); Sungkil Lee, Su-won-si (KR); Hans-Peter Seidel, St. Ingbert (DE); Elmar Eisemann, Delft (NL)

(72) Inventors: Matthias Hullin, Saarbrucken (DE); Sungkil Lee, Su-won-si (KR); Hans-Peter Seidel, St. Ingbert (DE); Elmar Eisemann, Delft (NL)

(73) Assignees: UNIVERSITAT DES SAARLANDES, Saarbrucken (DE); MAX-PLANCK-GESELLSCHAFT ZUR FORDERUNG DER WISSENSCHAFTEN E.V., Munchen (DE)

(21) Appl. No.: 14/114,747

(22) PCT Filed: Apr. 29, 2011
(86) PCT No.: PCT/EP2011/056850

§ 371 Date: Apr. 15, 2014

(51) Int. Cl. G06T 11/00

(52) U.S. Cl. CPC G06T 11/001
USPC 345/589

(57) ABSTRACT

A method and device for efficiently simulating lens flares produced by an optical system is provided. The method comprises the steps of—Simulating paths of rays from a light source through the optical system, the rays representing light; and Estimating, for points in a sensor plane, an irradiance, based on intersections of the simulated paths with the sensor plane.

The present invention relates to a method and a system for real-time lens flare rendering.

### TECHNICAL BACKGROUND

Lens flare is an effect caused by light passing through a photographic lens in any other way than the one intended by design, most importantly through interreflection between optical elements. Flare becomes most prominent when a small number of very bright lights are present in a scene. In traditional photography and cinematography, lens flare is considered a degrading artifact and therefore undesired. Among the measures to reduce flare in an optical system are optimized barrel designs, antireflective coatings, and lens hoods.

On the other hand, flare or flare-like effects have often been used deliberately to achieve an increase in realism or perceived dynamic range. Many image and video editing packages feature filters for the generation of “flare” effects, and in video games the effect is just as popular. In the production of computer-generated feature movies, great effort has been taken to model cinema lenses with all their physical flaws and limitations.

The problem of rendering lens flares has been approached from two ends. A very simple and efficient, but not quite accurate, technique is the use of static textures (starbursts, circles and rings) that move according to the position of the light source, and are composited additively to the base image. Flares generated from texture billboards can look convincing in many situations, yet they fail to capture the intricate dynamics and variations of real lens flare.

On the other end of the scale, very sophisticated techniques have been demonstrated that involve ray or path tracing through a virtual lens with all of its optical elements. The results are near accurate but very costly to compute, with typical rendering times in the order of several hours per frame on a current desktop computer. Furthermore, many samples end up being blocked in the lens system, which wastes much of the computation time and leads to a slow convergence. Also, the solution only holds within the limits of geometric optics. Wave-optical effects, however, cause some phenomena encountered in real lens flares. Integrating them into a ray-optical framework is by no means trivial and further increases the computational cost.

### PRIOR ART

Previous interactive methods are based on significant approximations. For example, it was suggested to use texture sprites that are blended into the framebuffer and arranged on a line through the screen center. Their position may be determined with an ad hoc displacement function. Size and opacity variation adapted by hand and depending on the angle between the light and camera have also been used. Additionally, a brightness variation of the flare has been proposed, that can also be controlled depending on the number of visible pixels of an area light. In none of these cases however, an underlying camera or lens model was considered.

In other situations, more accurate simulations are needed. For example, when compositing virtual and realistic content, when designing lens systems, or when predicting the appearance of a scene through a lens system. Previous high-quality approximations rely on path tracing or photon mapping. While such approaches deliver theoretically a high quality, several aspects; such as spectral (e.g., chromatic aberration, or lens coating), diffraction effects, or aperture shape, are usually ignored. Furthermore, the visual quality for small computation times can be insufficient, making interaction (e.g., zooming) impossible.

### OBJECT OF THE INVENTION

It is therefore an object of the present invention to provide an improved method and system for efficiently rendering realistic lens flares.

### SUMMARY OF THE INVENTION

This object is achieved by a method and a system according to the independent claims. Advantageous embodiments are defined in the dependent claims.

According to the invention, a method for simulating and rendering flares that are produced by a given optical system in real time may be based on tracing, i.e. on simulating, the paths of a select set of rays through the optical system and using the results of the simulation for estimating a point's irradiance in the film, i.e. sensor plane.

The invention provides a physically-based simulation that runs at interactive to realtime performance. Further, the inventive solution may be adapted to exaggerate or replace physical components. Its initial faithfulness ensures that the resulting imagery keeps a convincing and plausible appearance even after applying significant artistic tweaks.

### BRIEF DESCRIPTION OF THE FIGURES

These and other aspects and advantages of the present invention may further be understood when reading the following detailed description of an embodiment of the invention, together with the annexed drawing, in which

FIG. 1 is a block diagram showing different aspects of optical systems considered by the invention.

FIG. 2 shows an example plot of the reflection coefficients for a quarter-wave coating, depending on a wavelength λ and an incident angle θ.

FIG. 3 shows an example transition of an octagonal aperture function from spatial to Fourier domain.

FIG. 4 shows a blade (a) and an aperture of an optical system (b).

FIG. 5 shows a flowchart of a method for simulating and rendering flares according to an embodiment of the invention.

FIG. 6 shows an example of a two-reflection sequence for an Itoh lens.

FIG. 7 shows the difference between intersecting rays with the nearest surface (a) and intersecting rays with a virtually extended lens surface according to an embodiment of the invention (b).

FIG. 8 shows a ray grid on the sensor plane, formed by the rays that have been traced through an optical system by the method described in connection with FIG. 5.

FIG. 9 shows performance ratings for an implementation of the method described in connection with FIG. 5, for different lens systems and quality settings.

### DETAILED DESCRIPTION OF THE INVENTION

The main idea behind the inventive technique is not only to consider individual rays, but to exploit a strong coherence of rays within lens flare, in the sense of choosing rays underlying the same interactions with the optical system.

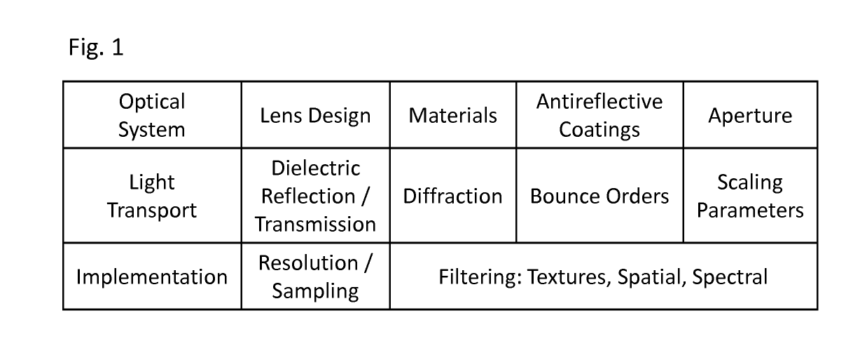

FIG. 1 is a block diagram showing different aspects of optical systems considered by the invention. Generally, an optical system may comprise lenses and an aperture, each lens having a specific design, material and possibly, coating. Light propagation is governed by light transmission, and reflection at the set of lens surfaces and characteristic planes (entrance, aperture and sensor plane).

Specific lens designs of a given optical system may be modeled geometrically as a set of algebraically defined surfaces, i.e., spheres and planes. In terms of materials or optical media, it is sufficient for a method according to the present embodiment of the invention to consider perfect dielectrics with a real-valued refractive index. All optical glasses are dispersive media, i.e., the refractive index n is a function of the wavelength of light λ.

Sellmeier's empirical approximation may be used to describe the dispersion of optical glasses:

$${n}^{2} ( λ ) = a + \frac{b {λ}^{2}}{c - {λ}^{2}} + \frac{d {λ}^{2}}{e - {λ}^{2}} + \frac{f {λ}^{2}}{g - {λ}^{2}} \qquad ( 1 )$$

where a, b, c, d, e, f, and g are material constants that can be obtained from manufacturer databases, e.g. an optical glass catalogue from Schott AG or from other sources, such as http://refractiveindex.info.

Every time a ray of light hits an interface between two different media, a part of it is reflected, and the rest transmitted. For smooth surfaces, it may be assumed that the relative amounts follow Fresnel's equations, with the resulting ray directions according to the law of reflection and Snell's law. The Fresnel equations provide different transmission and reflection coefficients for different states of polarization. For unpolarized light propagating from medium 1 to medium 2 (with refractive indices nᵢ and angles with respect to the normal θᵢ), the overall reflection coefficient R and transmission coefficient T of a surface may be expressed as

$$R = \frac{1}{2} {( \frac{{n}_{1} cos {θ}_{1} - {n}_{2} cos {θ}_{2}}{{n}_{1} cos {θ}_{1} + {n}_{2} cos {θ}_{2}} )}^{2} + \frac{1}{2} {( \frac{{n}_{1} cos {θ}_{2} - {n}_{2} cos {θ}_{1}}{{n}_{1} cos {θ}_{2} + {n}_{2} cos {θ}_{1}} )}^{2} \\ and \\ T = 1 - R . \qquad ( 2 )$$

However, in an attempt to minimize reflections, optical surfaces often feature antireflective coatings. They consist of layers of clear materials with different refractive index. Light waves that are reflected at different interfaces are superimposed and interfere with each other. In particular, if two reflections have opposite phase and identical amplitude, they cancel each other out, reducing the net reflectivity of the surface. The parameters of the multi-layer coatings used for high-end lenses are well-kept secrets of the manufacturers. But even the best available coatings are not perfect. A residual reflectivity always remains. It is a function of wavelength and angle, R(λ, θ). Reflections in a coated surface therefore change color depending on the angle. Furthermore, a look into a real lens reveals that different interfaces reflect white light in different colors, suggesting that they are all coated differently. The resulting reflection residuals lead to characteristic rainbow-colored lens flares.

Without the resources to reverse engineer exact characteristics, the inventors chose a so-called quarter-wave coating. It consists of a single thin layer. With this kind of coating, the reflectivity of the surface can be minimized for a center wavelength λ₀, given an angle of incidence, θ₀. This requires a solid material of very low refractive index; in practice, the best choice is often M_{g}F₂(n=1.38). The layer thickness is chosen to result in a phase shift of π/2 (quarter period).

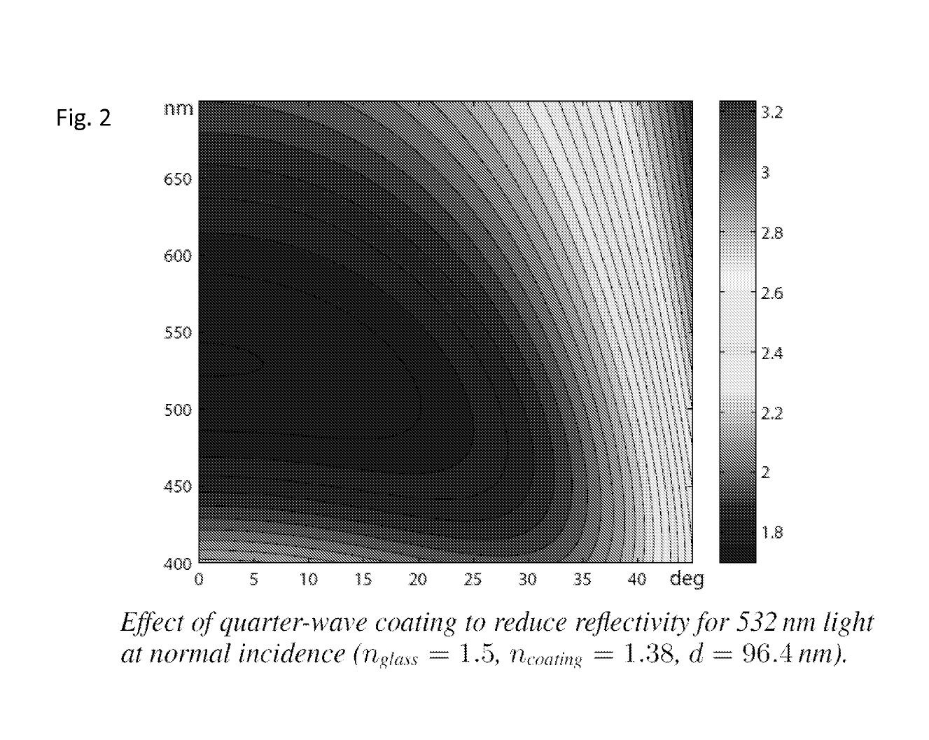

While an analytical expression for R(λ, θ) may be derived in most cases, even the simple quarter-wave coating involves multiple instances of the Fresnel equations, making the expression relatively complex. An example plot for a quarter-wave coating is shown in FIG. 2. One way to approximate such a function is to store it in a pre-computed 2D texture, which also allows to record or use arbitrary available coating functions. In practice, the GPU's arithmetic power is usually high enough to evaluate the function directly.

Appendix A shows an example of a computation scheme for the reflectivity R(λ, θ) of a surface coated with a single layer. The computation scheme also illustrates how polarization may be handled. Although an overall model of the optical system may assume unpolarized light, the computation scheme of appendix A distinguishes between p- and s-polarized light, since light waves only interfere with other waves of the same polarization.

Some of the effects that constitute real lens flare cannot be explained in a purely geometrical framework. As light waves traverse the optical systems, they are partially blocked by small-scale geometry (edges). The remaining parts of the wave front superimpose and form diffraction patterns. Exact computation of diffraction is expensive since it requires an integral over the transmission function for each image point. However, for the limit cases of near-field and far-field diffraction, the Fresnel and Fraunhofer approximations can be employed, respectively. Conveniently, both can be expressed in terms of Fourier transformations.

Far field (Fraunhofer): Up to a few factors for intensity and scaling (and potential non-linearities for large angles), the far-field amplitude distribution is proportional to the Fourier transformed transmission function. The size of the diffraction pattern is proportional to the wavelength, and its intensity must be scaled to preserve the overall power of the transmitted light.

For a given aperture function, plausible starbursts can be obtained by overlaying scaled copies of the aperture's FFT.

Near-Field (Fresnel): It has further been recognized by the optics community that, when the transformation from the spatial domain to the Fourier domain occurs through free-space propagation, intermediate field distributions of the diffracted wave can be obtained using the fractional Fourier transform (FrFT). The FrFT is a linear transformation that generalizes the standard Fourier transform to fractional powers, gradually rotating a signal from the spatial into the frequency domain. There exist various definitions of the FrFT based on propagation in graded-index media or the Wigner distribution functions, and they have been shown to be equivalent.

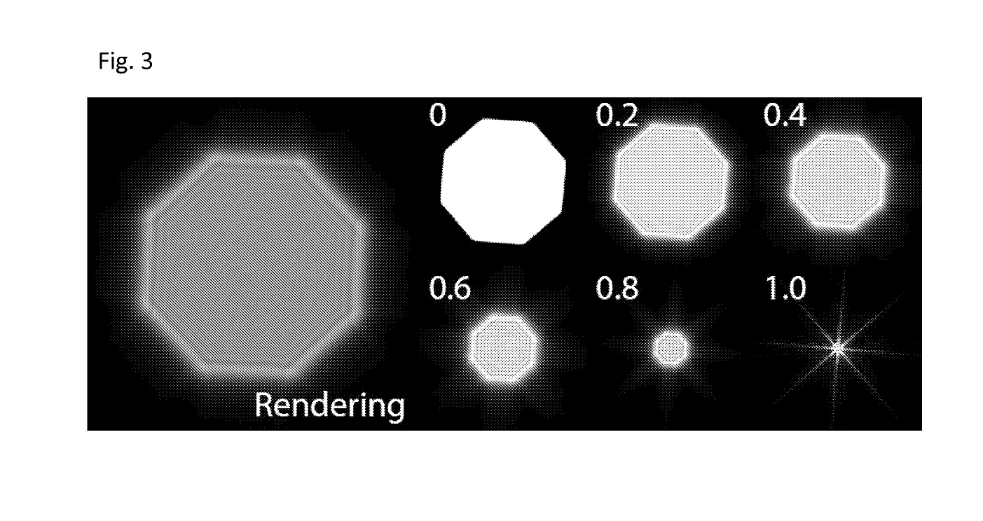

FIG. 3 shows an example transition of an octagonal aperture function from spatial to Fourier domain. On the left-hand side, the aperture is transformed by 20%, while the right-hand side shows the transformation for a collection of different fractional powers.

However, in the inventive system, the assumption of free-space propagation does not hold. Computing the exact scalings and coefficients for diffraction patterns is not impossible, but hard due to the complexity of the optical system. By manually adjusting the few parameters, the look of real diffraction patterns may be closely reproduced.

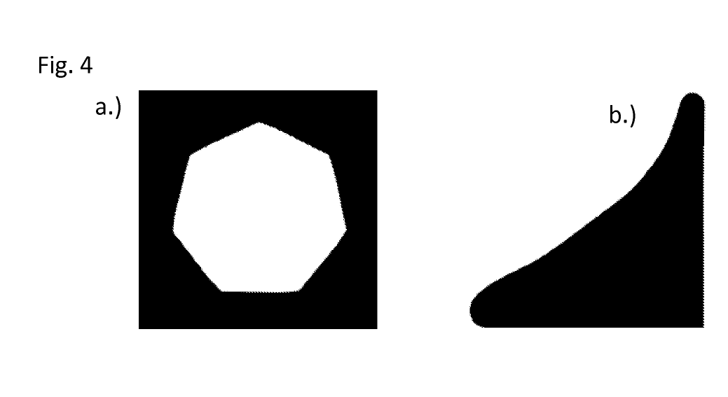

FIG. 4a shows the shape of an individual blade of an aperture. In real optical systems, the aperture consists of mechanical blades that control the size of a pupil by rotating into place. When the aperture is fully open, the blades are hidden in the lens barrel, resulting in a circular cross-section. Stopping down the aperture leads to a polygonal contour defined by number, shape and position of the blades.

FIG. 4b shows the shape of an aperture. It may be simulated by combining multiple rotated copies of a base contour to form the proper aperture shape, which may be stored in a texture.

Depending on the requirements of the application, the above-described aspects may be skipped to simplify the model and increase the performance. They should rather be considered as building bricks that can either be modeled as accurately as desired, exaggerated, or altered in an artistically desired way.

Now, the rendering technique to simulate the actual light propagation will be described. It is based on ray tracing through the optical system to the film plane (sensor). In contrast to expensive off-line approaches, only a sparse set of rays may be traced. Each ray may record values about the lens-system traversal. When reaching the sensor, a ray corresponds to an image position. These rays implicitly define a ray grid across which the recorded values may be interpolated. Hereby, the outcome of rays may be approximated that were never actually shot, leading to an approximate beam tracing.

For the purpose of the following description, a directional, or distant, light source shall be assumed, which holds for most sources of flare (e.g., sunlight, street lights, and car headlamps). This assumption is not a necessary requirement of the inventive method, but helpful for its acceleration.

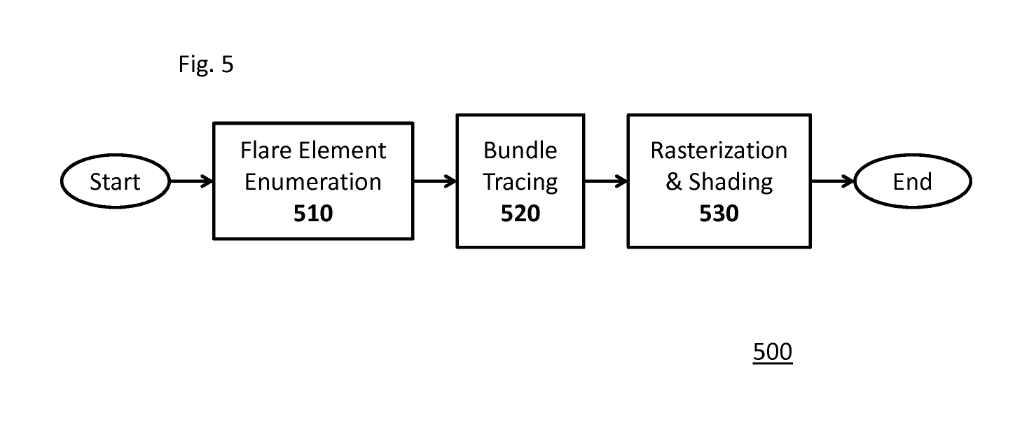

FIG. 5 shows a flowchart of a method 500 for simulating and rendering flares according to an embodiment of the invention.

In step 510, lens flare elements are enumerated, based on a model of the optical systems as described above.

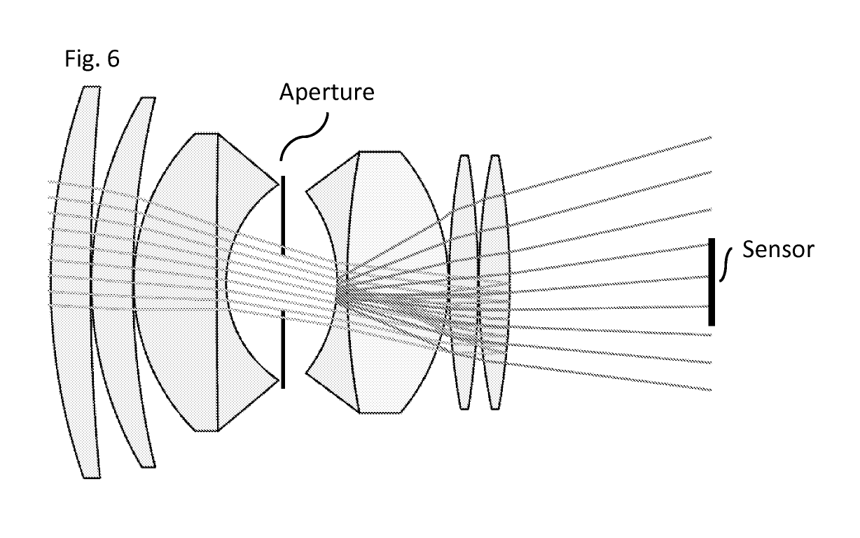

Rays traversing the lens system are reflected or refracted at lenses. Each flare element corresponds to a fixed sequence of these transmissions and reflections. An example of a two-reflection sequence for an Itoh lens is shown in FIG. 6. Sequences with more than two reflections may usually be ignored; only a small percentage of light is reflected and they are typically by orders of magnitude weakened leading to insignificant contributions in the final image.

Preferably, all two-reflection sequences are enumerated: light enters the lens barrel, propagates towards the sensor, is reflected at an optical surface, travels back, is again reflected, and, finally, reaches the sensor.

For n Fresnel interfaces in an optical system, there are N=n(n−1)/2 such sequences that may be treated independently to produce their lens flare elements.

For a given flare element and incident light direction, a parallel bundle of rays is spanned by the entrance aperture of the lens barrel.

In step 520, a sparse set of rays is selected from each bundle for tracking their paths through the optical system. As the set of rays is associated with a flare element, it is uniform in the sense that the path of each ray through the optical system comprises a fixed number of reflections associated with the flare element. Because the sequence of the intersections is known for each flare element, unlike classical ray tracing, it is not necessary to follow each ray with a recursive scheme, elaborate intersection tests, or spatial acceleration structures. Instead, the sequence may be parsed into a deterministic order of intersection tests against the algebraically-defined lens surfaces. This makes the inventive technique particularly well suited for GPU execution.

At each intersection, the hitpoint of the ray may be compared with the diameter of the respective surface and it may be recorded, how far off a ray has been along its way through the system:

rᵣₑₗ^{(new)}=max(rᵣₑₗ^{(old)}, r/r_{surface})

where r is the distance of the hitpoint to the optical axis, and r_{surface} the radius of the optical element. Also, as a ray passes through the aperture plane, a pair of intersection coordinates (uₐ, vₐ) is stored.

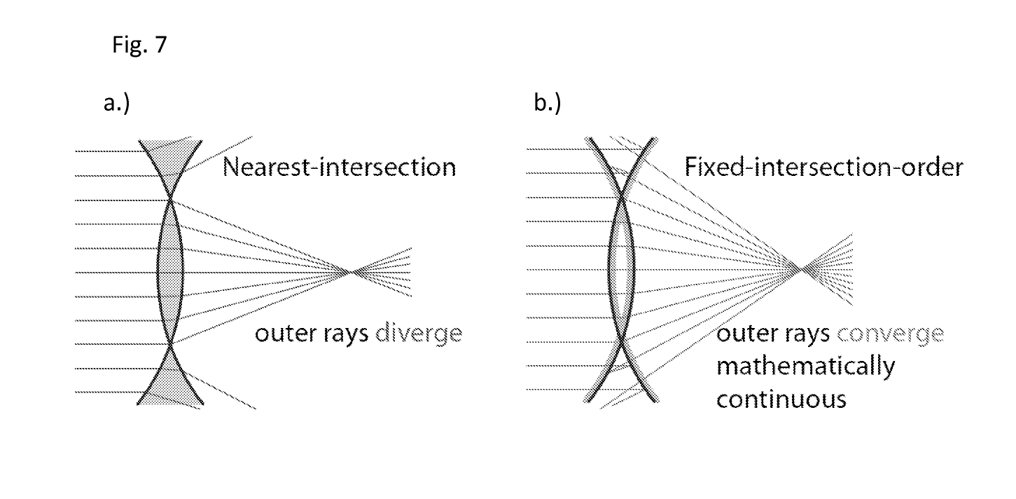

Rays that escape from the system (rᵣₑₗ>1) must not be discarded since even these are valuable for interpolation in the ray grid (see below). For this purpose, lens surfaces may be extended virtually beyond their actual extent, as shown in FIG. 7. In fact, the lens functionality may be mathematically extrapolated beyond the lens diameter. All that is necessary is to keep the in-order treatment of the surface. Hereby, the numerical stability of the simulation is greatly increased, which would not be the case for standard ray tracing. This leads to more rays that pass through the system in a mathematically continuous way. Only when a ray can no longer be intersected with the next surface, or undergoes total internal reflection, it is pruned. Pruning can create holes in the ray grid, but refinement strategies are not needed. In practical trials by the inventors, it proved to be unproblematic because the rays transported energy approaches zero in the vicinity of total inner reflection, making its neighbors and the area on the ray grid appear black in the final rendering anyway.

In step 530, the final image in the sensor plane is obtained by rasterization and shading

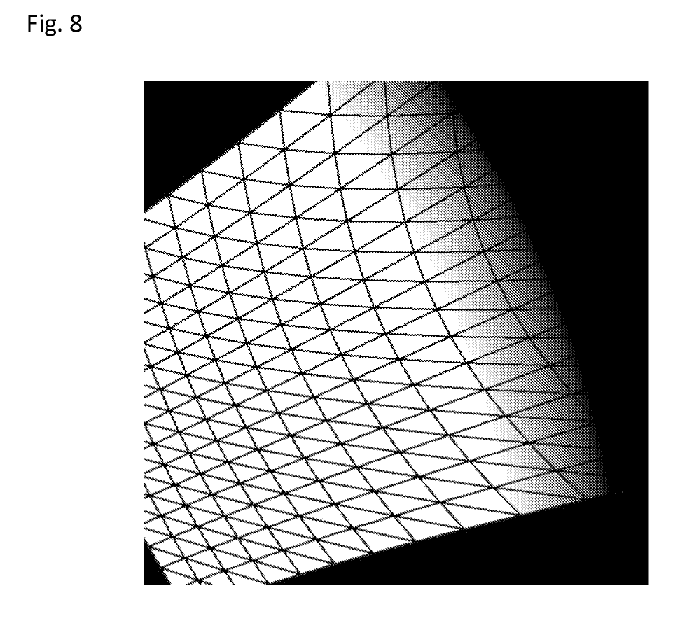

Once the rays have been traced through the system, they form a ray grid on the sensor plane, as shown in FIG. 8. The set of rays is sparse and would only deliver insufficient quality. The objective is to interpolate information from neighboring rays to estimate the behavior of an entire ray beam. To this extent, rather than using a random sparse set of rays, the ray set may be initialized as a uniform grid placed at the first lens element. Each grid cell on the entrance plane may be matched to a grid cell on the sensor between the same rays. Similar to traditional beam tracing, the total radiant power transported through each beam is now distributed evenly over the area of the corresponding quad, leading to intensity variations in the lens flare. If a beam is focused on an area smaller than the beam's original diameter, the irradiance for that smaller area grows accordingly. Additional shading terms (in particular, Lambertian cosine terms) may be taken into account.

One important observation is that rays that are blocked are not culled by the lens system or aperture, but the position where they traverse the aperture (uₐ, vₐ), and its maximum distance to the optical axis, rᵣₑₗ, with respect to the radius of the respective surface is recorded. When treating a beam, these coordinates may be interpolated over the corresponding quad. Hereby, more accurate inside/outside checks for the interpolated rays become possible; clipping is applied when the interpolated radius exceeds the limit distance. Finally, the position on the aperture may be used to determine the flare shape by a lookup in an aperture texture. Here, also Fresnel diffraction comes in, since the ringing pattern has been pre-computed and stored in the aperture texture.

In order to improve the speed and quality of the above described method and/or to save computational resources, the set of rays to be traced may be limited to a subset of rays that actually propagate all the way to the sensor, without hitting obstacles. In particular, for small aperture diameters, most rays are actually blocked in the aperture plane. According to the invention, the sparse set of rays may therefore be limited to a region on the entrance aperture that encloses all rays that might potentially hit the sensor. Hereby, the ray grid on the sensor will be concentrated around the actual lens flare element.

The bounding region on the entrance aperture depends on the light direction, aperture size, and possibly other parameters (zoom, or focus), making a run-time evaluation difficult. Instead, the invention proposes a preprocessing step to estimate the size and position of each lens flare.

For a given configuration, the previous basic algorithm may be employed with a low resolution grid to recover all rays that actually reach the sensor. Their position on the entrance aperture may then be used to define the bounding region, e.g. a rectangle. In theory, this solution might not be conservative, but, in practice, artifacts could be avoided with a simple solution. The derived bounding regions are extended slightly by taking the neighboring configurations into account. Preferably, a bounding rectangle may be determined that encompasses all bounding rectangles of the immediate neighbors which proved sufficient for all cases.

In practice, the process may further be improved by using an adaptive strategy instead of a brute-force sampling, e.g. by employing an interval subdivision guided by the variance in the bounding shape estimations.

In order to capture subtle changes introduced by specifics of the optical system, without sacrificing too much computational resources, the grid resolution for each flare element may be adapted at runtime. More specifically, lens flares may be considered as caustics of a complex optical system, which also implies that very high frequencies can occur. In the above-described embodiment of a method according to the invention, a regular grid of incident rays is mapped to a more or less homogeneous grid on the sensor. In most cases, the grid undergoes simple scaling and translation which is captured with sufficient precision even for a coarse tessellation. In some configurations, though, the accumulation of nonlinear effects may cause severe deformations, fold the grid onto itself, or even change its topology. Such flares require a higher grid resolution.

In order to adapt the grid resolution for each flare at runtime, a suitable heuristic may employ the area of grid cells as an indicator. A large variance across the grid implies that a non-uniform deformation occurred and more precision is needed. While one could always start with a small resolution, it is more efficient to initialize the grid resolution based on ratios that are measured from the ray bounding pre-computation. Based on variance, one out of six levels of detail may be used (with resolutions between 16×16 to 512×512 rays per bundle).

An approximate intensity of the resulting flare may also be derived during the pre-computation step. This allows sorting the flares according to their approximate intensity, i.e. their potential impact. A user may then control the budget, even during runtime, by fixing the number of flares to be evaluated.

In order to further increase the efficiency of the above-described method, rays traversing the aperture twice may be disregarded. As these rays tend to be blocked anyhow, their omission usually does not introduce strong artifacts. Hereby, the number of enumerated sequences may be reduced significantly to N=(f(f−1)+b(b−1))/2, where f and b are the number of lens surfaces before and after the aperture respectively.

In order to reduce computational complexity, the above described embodiment of a method according to the invention may also exploit symmetries in the optical system. By design, most photographic lenses are axisymmetric, whereas anamorphic lenses featuring two orthogonal planes of symmetry that intersect along the optical axis are common in the film industry. For axial symmetry, the amount of required pre-computation may be reduced drastically; all computation up to and including the ray tracing may be done for a fixed azimuthal angle of incidence, and then rotated into place. Furthermore, the sparse ray set may be reduced by exploiting the mirror symmetry of the flare arrangement, only considering half the rays on the entrance plane. The grid on the sensor may then be mirrored along the symmetry axis. Most notably, not blocking rays directly, but recording aperture coordinates and intersection distances, allows considering the whole system as symmetric (even the aperture, which, in general, is asymmetric).

Another gain in computational efficiency may be achieved by combining a reduction in the number of wavelength-dependent evaluations with an interpolation strategy. More particularly, treating antireflective coating and chromatic lens aberrations requires a wavelength-dependent evaluation. For a brute-force evaluation, most flares are well represented with only three wavelengths (RGB), but a few (typically, in extreme cases, three out of 140 flares), can require up to 60 wavelengths for smooth results. In an embodiment of the invention, the number of wavelengths may be limited to 3 (standard quality/RGB) or a maximum of 7 (high quality) wavelengths, implying only a moderate computational cost. The result for a wavelength may be rendered and a filter may be used in image space to create transitions. From the spatial variation between neighboring wavelength bands, the orientation and dimension of the needed 1D blur kernel may be determined per spectral flare. The filtered representations may then be blended together in the RGBA frame buffer and deliver a smooth result.

Lens flare can also be a creative tool to increase the appeal of images. The inventive algorithm offers many possibilities to interact with the basic pipeline in order to exceed physical limitations while maintaining a plausible look. For example, the inventive method does not make any assumptions concerning the aperture shape. Arbitrary definitions are possible, allowing indirect control of diffraction effects. Similarly, a user may draw the diffraction ringing and apply a Fourier transform to reconstitute the aperture. As the shape of the aperture appears also in form of ghosting, it may be interesting to handle both effects with differing definitions.

Moreover, lenses in the real world are often degraded by dust and imperfections on the surface that can affect the diffraction pattern. This effect may be controlled by adding a texture of dust and scratches to the aperture before determining the Fourier spectrum. Drawing a dirt texture is possible, but also a procedural generation of scratches and dust may be offered based on user defined statistics (density, orientation, length, size). While scratches add new streaks to the lens flare, dust has a tendency to add rainbow-like effects. One particularly interesting possibility is to animate the texture and achieve dynamic glare.

Since real lens systems are also never exactly symmetric, real flare elements can be slightly off the mirror axis. To control this imperfection, a variance value can be added that translates each flare element slightly in the image plane. Such a direct modification is more intuitive than a corresponding change in the lens system.

Finally, in order to control color fringes of flares due to lens coating, a user may interactively provide color ramps or even global color changes for each flare.

The method according to the invention may be implemented on a computer. Preferably, the computer comprises a state-of-the-art graphics processing unit (GPU), because the inventive method is well adapted to graphics hardware. More particularly, the ray tracing may be performed in a vertex shader of the GPU. The resulting distortion may be analyzed in the geometry shader and the energy may be adapted. Based on distortion, the pattern may be refined if needed. In modern graphics processing cards, this step may be executed by a tessellation unit. To deal with total reflection, culled rays may be flagged via a texture coordinate, information that is then accessible to the geometry shader. The geometry shader produces the triangle strips that form the beam quads in the grid. For each quad the shading may be computed, taking the total radiant power into account. Furthermore, in case of a symmetric system, the sparse ray set may be halved and each triangle needs to be mirrored along the symmetry axis which may be determined from the light position and the image center. This doubling of triangles is more efficient than image-based mirroring. The resulting quads on the sensor may be rasterized in the fragment shader that can discard fragments if they correspond to blocked rays, which is determined via a distance value. A texture lookup based on the aperture coordinate may complete the final rendering in which all flares are composited additively. An improvement in quality may be achieved by not shading quads, but vertices. Then, the values may be interpolated in the fragment shader and deliver smooth variations, as for Gouraud shading. At each vertex, the average value of its surrounding neighbors may be stored. While accessing neighbor vertices is usually difficult, it is easy for a regular grid. To gain access to the vertices, they may be captured via the transform feedback mechanism of modern hardware. Alternatively, a texture may be written with the resulting values instead. In a second pass, the needed values may simply be recovered per vertex by using easy-to-determine offsets.

In order to evaluate the above-described method, the inventors implemented it on an Intel Core 2 Quad 2.83 GHz with an NVIDIA GTX 285 card. The method reaches interactive to real-time frame rates depending on the complexity of the optical system, and the accuracy of the simulation.

Therefore, it can be of interest for demanding real-time applications, but also for higher-quality simulations. For performance, one could even pick only those flares that are particularly beautiful, yielding a significant speedup while maintaining the artistic expression. In practice, culling the 20% weakest flares using the inventive intensity LOD delivers 20% speedup without introducing visible artifacts. Even 40% still proved acceptable for interactive applications (speedup approx. 50%).

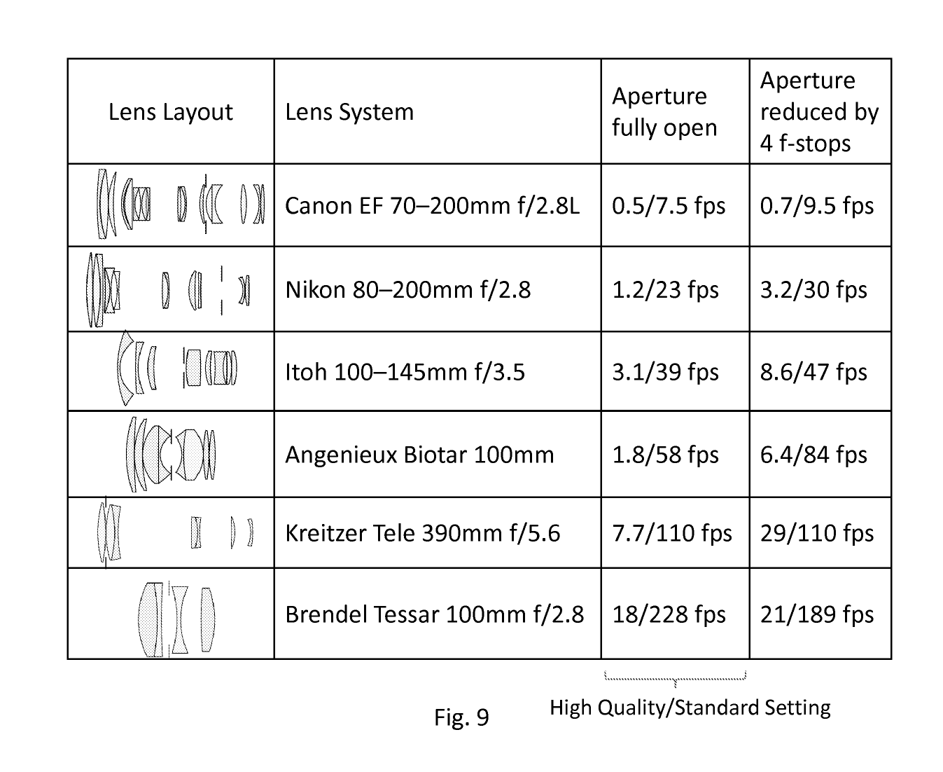

FIG. 9 shows performance ratings for different lens systems and quality settings. Frames per second (Fps) are given for standard and high quality (more rays do not bring improvement) settings. The most costly effects of the inventive method are caustics in highly anisotropic flares because ray bundles in such flares are spatially and spectrally incoherent.

The inventive solution performs a reasonably quick pre-computation step to bound the sparse set of rays. For a simple lens, such as a Brendel prime lens (9 flares), it takes less than 0.1 sec, for a Nikon zoom lens (142 flares), it takes 5 minutes, for the Canon zoom lens (312 flares), it takes 20 min (all: flares×90 light directions×64² rays×20 zoom factor×8 aperture stops, the latter two allow to freely change camera settings on the fly.

The inventive method produces physically-plausible lens flares. Most important effects are simulated convincingly, leading to images that are hard to distinguish from realworld footage. The main difference arises from imperfections of the lens system and the approximate handling of diffraction effects according to the invention. Furthermore, the real lens coating is unknown, the invention works with an estimate.

The shape of the flare elements is rather faithfully captured. The inventive method handles complex deformations and caustics (FIG. 15). Previous real-time methods were unable to obtain similar results because ray paths were entirely ignored. Only costly path tracing captured this effect, but did deliver a comparable quality in a reasonable computation time. The inventive model considers many aspects that were previously neglected (e.g., the reflectivity of lens coatings as a function of wavelength and angle). Even with these improvements and at highest spatial and spectral resolutions, rendering flares for even the most complex optical designs takes no more than a few seconds. This is significantly faster than a typical path-traced solution that would take hours, if not days, to converge on today's desktop computers.

The memory consumption of the inventive approach is mainly defined by the textures containing the aperture and its Fourier transform (24 MB worth of 16-bit float data), as well as three render buffers (another 24 MB).

The inventive approach may be used in lens-system design to preview lens flare appearance, useful for manufacturers of lens systems. In particular, nowadays, an increasing amount of designer-lens systems becomes available that exaggerate various lens aberrations or similarly lens flares. Being able to predict such effects is particularly interesting.

More particularly, the inventive technique delivers high quality that exceeds many previous offline approaches, making it even interesting as a final rendering solution. The added artistic control allows a user to maintain a realistic appearance while being able to fine-tune the appearance.

In order to use the simulation in a computer game, costly calculations may be deactivated. Furthermore, the two-reflection assumption allows the user to chose particular flare elements considered important. Furthermore, for well-behaved flares, even a very small amount of rays (for example 4×4) delivers high quality with the inventive interpolation,

The inventive methods are also useful in image and video processing. Current video lens flare filters do not appear convincing because they keep a static look, e.g., flare deformations are ignored. The inventive method is temporally coherent, making it a good choice for movie footage as well. Light sources in the image may be detected and followed using an intensity threshold. One could also animate the light manually to emphasize elements or guide the observer. The instant feedback according to the invention is of great help in this context.

Finally, it must be noted that the invention is not limited to the embodiments previously discussed. More particularly, a rendering mechanism according to the invention may sample area light sources instead of approximating them by a point light, at an additional computational cost.

APPENDIX A
Single-Layer AR Coating

In:
theta1(angle of incidence)
lambda (wavelength)
n1, n2 (refractive indices of media)
nC, dC (refractive index and thickness of coating)
// Typically for quarter wave coating;
nC = max(sqrt(n1*n2),1.38),dC = lambda/4/nC
Out:
R(reflectivity)
-----------------------------------------------------------------------
thetaC = asin(sin(theta1)*n1/nC);
theta2 = asin(sin(theta1)*n1/n2);
// amplitude for outer reflection/transmission on topmost interface.
rs1 = −sin(theta1 − thetaC)/sin(theta1 + thetaC);
rp1 = tan(theta1 − thetaC)/tan(theta1 + thetaC);
ts1 = 2*sin(thetaC)*cos(theta1)/sin(theta1+thetaC);
tp1 = 2*sin(thetaC)*cos(theta1)/sin(theta1+thetaC)*cos(theta1+thetaC);
// amplitude for inner Fresnel reflection
rs2 = −sin(thetaC − theta2)/sin(thetaC + theta2);
rp2 = tan(thetaC − theta2)/tan(thetaC + theta2);
//after passing through first surface twice two transmissions an one
reflection
ris = ts1\hat{ }2*rs2;
rip = tp1\hat{ }2*rp2;
// phase difference between outer and inner reflections
dy = dC*nC;
dx = tan(thetaC)*dy;
delay = sqrt(dx\hat{‘}2 + dy\hat{ }2)
relPhase = 4*PI/lambda*(delay − dx*sin(theta1));
// optional: phase flip inf not (n0<n1<n2 || n0>n1>n2).
// Not needed for coatings of lower refractive index
// if (n1 > nC) relPhase += PI;
// if (nC > n2) relPhase += PI;
// Add sines of different phase and amplitude (trigonometrical identity
)
out_s2 = rs01’+ ris’+ 2*rs1*ris*cos(relPhase);
out_p2 = rp01’+ rip’+ 2*rp1*rip*cos(relPhase);
R = (out_s2 + out_p2)/2;

1. Method for simulating lens flares produced by an optical system, comprising the steps:
simulating paths of rays from a light source through the optical system, the rays representing light;
estimating, for points in a sensor plane, an irradiance, based on intersections of the simulated paths with the sensor plane.

2. Method according to claim 1, wherein the number of times a ray is reflected by a surface of the optical system, is fixed.

3. Method according to claim 2, wherein the fixed number of times is 2.

4. Method according to claim 1, wherein each ray's path passes through a bounded region of the entrance aperture of the optical system.

5. Method according to claim 4, wherein the bounds of the region are estimated in a pre-processing step.

6. Method according to claim 1, further comprising the step of generating a digital image, based on the estimated irradiance.

7. Method according to claim 1, wherein the number of rays is sparse.

8. Method according to claim 1, wherein the number of rays is adapted at runtime.

9. Method according to claim 8, wherein the number of rays is adapted based on a variance of the area of different cells formed by the intersections of the paths with the sensor plane.

10. Device for simulating lens flares produced by an optical system, comprising:
means for simulating paths of rays from a light source through the optical system, the rays representing light;
means for estimating, for points in a sensor plane, an irradiance, based on intersections of the simulated paths with the sensor plane.

11. Device according to claim 10, wherein the means for simulating paths of rays is a vertex shader of a graphics processing card.

12. Computer-readable medium storing a software that, when executed on a computer, implements a method according to claim 1.
